(19) United States
(12) Patent Application Publication
(10) Pub. No.: US 2026/0267773 A1
(43) Pub. Date: Sep. 10, 2026

(54) Dynamic Runtime Scoring and Selection of Machine Learning Models

(71) Applicant: Google LLC, Mountain View, CA (US)

(72) Inventors: Branden Michael Archer, Mountain View, CA (US); Mekhola Mukherjee, San Francisco, CA (US)

(21) Appl. No.: 19/071,692

(22) Filed: Mar. 5, 2025

(51) Int. Cl. G06F 11/3604

(52) U.S. Cl. CPC G06F 11/3612

(57) ABSTRACT

A method includes obtaining input data using a client device, and determining a plurality of attribute values, where the attribute values are associated with processing the input data using a client-side machine learning model and a server-side machine learning model. The method also includes determining, for each respective machine learning model of the client-side machine learning model and the server-side machine learning model, a corresponding capability value based on the plurality of attribute values. The corresponding capability value may represent a capability of the respective machine learning model for processing the input data under conditions represented by the plurality of attribute values. The method further includes selecting, from the client-side machine learning model and the server-side machine learning model and based on the corresponding capability values thereof, a preferred machine learning model for processing the input data, and providing the input data to the preferred machine learning model.

### BACKGROUND

Machine learning models may be used to process various types of data (e.g., images, audio, text, etc.) to generate various desirable outputs. In some cases, a plurality of different machine learning models may be available for performing a particular task. Each of these machine learning models may be associated with various trade-offs in how it performs the particular task. Thus, it may be desirable to consider these trade-offs when using one or more of the plurality of different machine learning models to perform the particular task.

### SUMMARY

A plurality of different machine learning models may each be configured to perform a same or similar task, but may vary in how they perform this task. For example, both a (smaller) client-side machine learning model and a (larger) server-side machine learning model may be available for performing the task. To select from among the plurality of different machine learning models, a plurality of attribute values associated with input data for the task may be determined. These attribute values may represent conditions/circumstances under which processing of the input data is expected to be performed. A corresponding capability value may be determined for each respective machine learning model of the plurality of machine learning models, and may quantify a capability of the respective machine learning model for processing the input data under conditions represented by the plurality of attribute values. The capability values may be used to select, from the plurality of machine learning models, a preferred machine learning model to which the input data may be provided for processing.

In a first example embodiment, input data may be obtained using a client device. A plurality of attribute values may be determined. The plurality of attribute values may be associated with processing the input data using (i) a client-side machine learning model executable on the client device and (ii) a server-side machine learning model executable on a server device that is communicatively connected to the client device. For each respective machine learning model of the client-side machine learning model and the server-side machine learning model, a corresponding capability value may be determined based on the plurality of attribute values. The corresponding capability value may represent a capability of the respective machine learning model for processing the input data under conditions represented by the plurality of attribute values. A preferred machine learning model for processing the input data may be selected from the client-side machine learning model and the server-side machine learning model and based on the corresponding capability values thereof. The input data may be provided to the preferred machine learning model.

In a second example embodiment, a system may include a processor and a non-transitory computer-readable medium having stored thereon instructions that, when executed by the processor, cause the processor to perform operations in accordance with the first example embodiment.

In a third example embodiment, a system may include a processor configured to perform operations in accordance with the first example embodiment.

In a fourth example embodiment, a non-transitory computer-readable medium may have stored thereon instructions that, when executed by a computing device, cause the computing device to perform operations in accordance with the first example embodiment.

In a fifth example embodiment, a computer program may include instructions for performing operations in accordance with the first example embodiment.

In a sixth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a computing device, in accordance with examples described herein.

FIG. 2 illustrates a computing system, in accordance with examples described herein.

FIG. 3 illustrates a model selection system, in accordance with examples described herein.

FIG. 4 illustrates a plurality of computing devices, in accordance with examples described herein.

FIG. 5 is a flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. Overview

A computing system may include a plurality of machine learning (ML) models, each of which may be configured to perform the same or similar task. These ML models may differ in how quickly, accurately, securely, and/or efficiently they perform the task. For example, the ML models may be executed by different computing devices with different computational capabilities (e.g., client device(s) and server device(s)), may include different numbers of trainable parameters, may be based on different training data sets, may have access to different supporting ML models (e.g., for assessing the quality of outputs), may include different security and/or privacy protections, and/or may have access to different context data, among other factors. As a result, some of these ML models may be more capable and/or suitable than other ML models for processing input data, and this capability/suitability may change over time (e.g., from query to query) with changes in the circumstances under which processing is requesting. Thus, it may be desirable to methodically and/or repeatably quantify the capability of each respective ML model of the plurality of ML models for responding to a particular input data under various circumstances, thereby allowing the most capable and/or suitable ML model to be used for responding to the particular input data.

Accordingly, a model selection system may be configured to determine a plurality of attribute values associated with processing the particular input data by a respective ML model of the plurality of ML models. These attribute values may represent and/or be indicative of factors, properties, and/or conditions that may and/or are likely to affect how well the respective ML model performs in connection with the particular input data. For example, the attribute values may represent and/or be used to determine the expected speed, accuracy, privacy, security, and/or efficiency of the respective ML model. The model selection system may be configured to use the plurality of attribute values to determine, for each respective ML model, a corresponding capability value. The corresponding capability value may indicate how capable the respective ML model is capable of processing the particular input data under conditions/circumstances represented by the plurality of attribute values.

The attribute values may change over time as ML models are retrained, utilization of the computing devices that execute the ML models change, energy costs and/or availability vary, context data changes, user preferences change, and/or different inputs are provided for processing. Accordingly, the corresponding capability value of the respective ML model may also change according to changes in the attribute values, thus quantifying how well the respective ML model is likely to operate relative to other ML models under the changing circumstances.

The capability values of the plurality of ML models may be used to select a preferred ML model for processing the input data. The preferred ML model may be the ML model that, given the conditions/circumstances in which processing of the given input data is requested, is most likely to provide improved and/or optimal performance relative to other available ML models. The improvement and/or optimality may represent a combined improvement in one or more of speed, accuracy, privacy, security, and/or efficiency of processing the given input data. The input data may be provided as input to the preferred ML model, thus routing the input data to the ML model that is likely to provide good and/or best performance under the circumstances in which processing of the input data is requested.

### II. Example Computing Devices and Systems

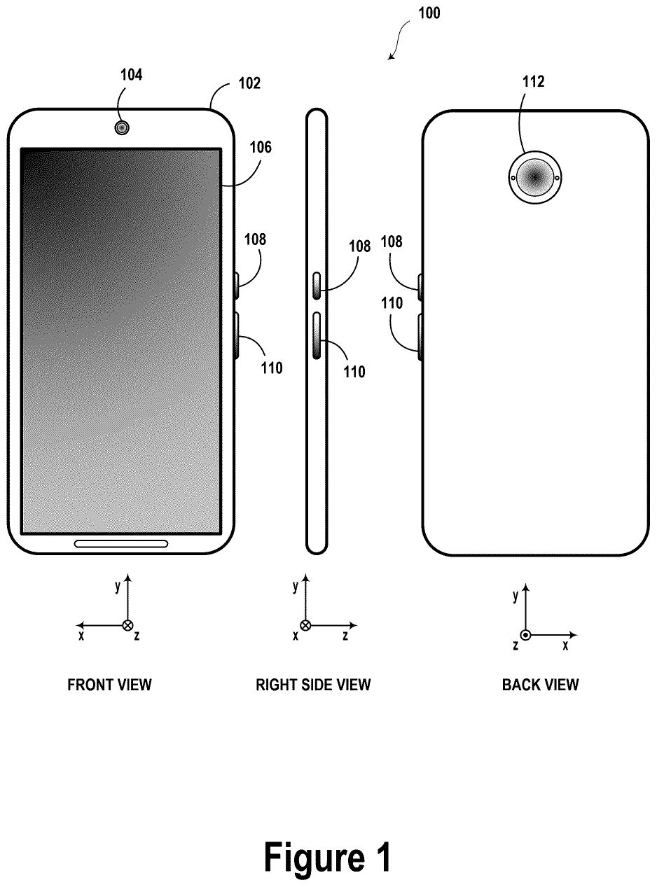

FIG. 1 illustrates an example computing device 100. Computing device 100 is shown in the form factor of a mobile phone. However, computing device 100 may be alternatively implemented as a laptop computer, a tablet computer, and/or a wearable computing device, among other possibilities. Computing device 100 may include various elements, such as body 102, display 106, and buttons 108 and 110. Computing device 100 may further include one or more cameras, such as front-facing camera 104 and rear-facing camera 112.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a viewfinder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

Computing device 100 could be configured to use display 106 and front-facing camera 104 and/or rear-facing camera 112 to capture images of a target object. The captured images could be a plurality of still images or a video stream. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing device 100 a predetermined distance, or according to a predetermined capture schedule.

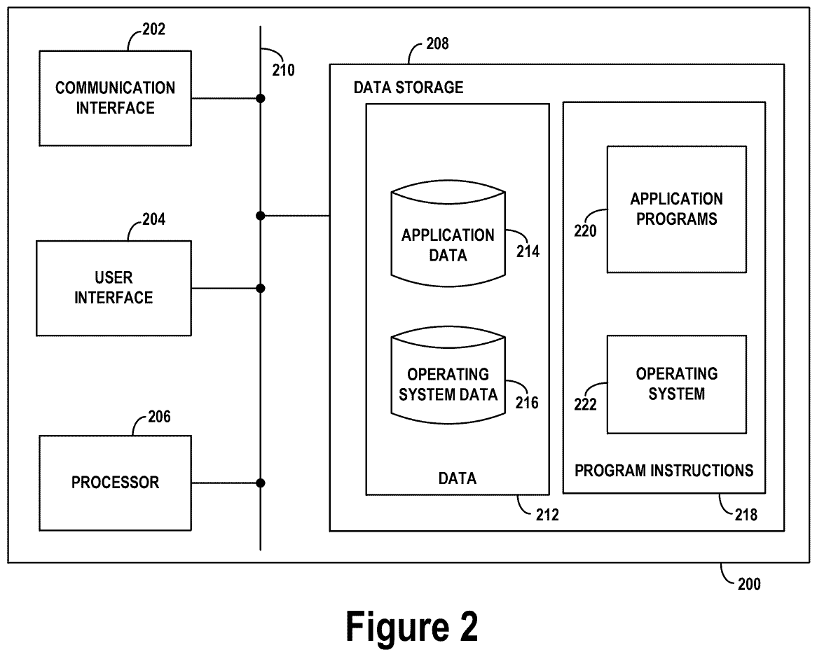

FIG. 2 is a simplified block diagram showing some of the components of an example computing system 200. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 2, computing system 200 may include communication interface 202, user interface 204, processor 206, and data storage 208, all of which may be communicatively linked together by a system bus, network, or other connection mechanism 210. Computing system 200 may be equipped with at least some image capture and/or image processing capabilities. It should be understood that computing system 200 may represent a physical image processing system, a particular physical hardware platform on which an image sensing and/or processing application operates in software, or other combinations of hardware and software that are configured to carry out image capture and/or processing functions.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors—e.g., microprocessors—and/or one or more special purpose processors—e.g., digital signal processors (DSPs), graphics processing units (GPUs), floating point units (FPUs), network processors, application-specific integrated circuits (ASICs), and/or tensor processing units (TPUs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

### III. Example Model Selection System

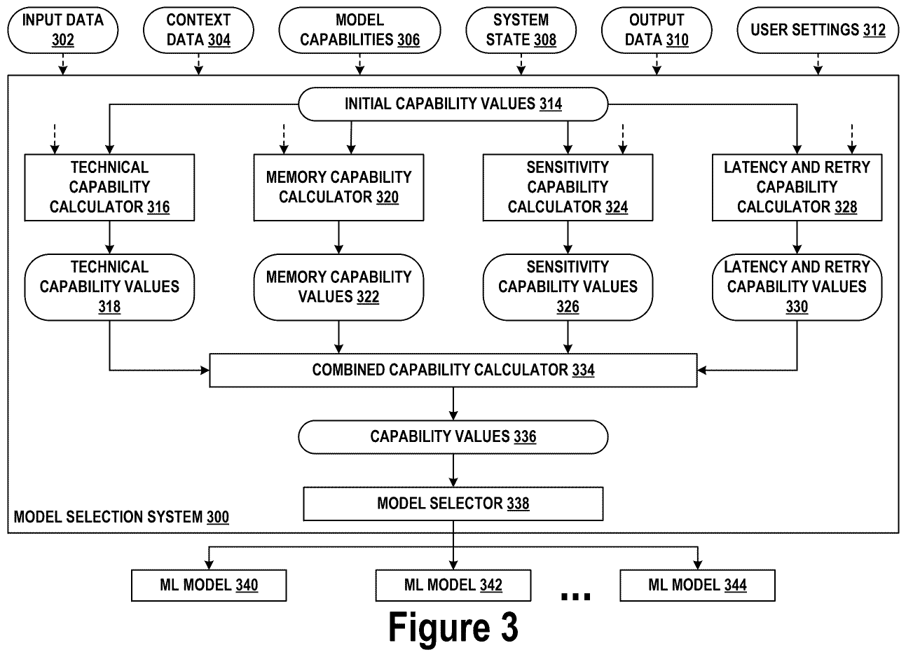

FIG. 3 illustrates an example model selection system 300 that may be used to select, from a plurality of machine learning (“ML”) models, a preferred ML model for processing input data. Specifically, model selection system 300 may include technical capability calculator 316, memory capability calculator 320, sensitivity capability calculator 324, latency and retry capability calculator 328, and model selector 338. Model selection system 300 may be configured to select, from ML model 340 and ML model 342 through 344 (“ML models 340-344”), at least one ML model by which to process input data 302 based on a plurality of attribute values associated with processing input data 302 by ML models 340-344. The selected ML model may be referred to as a preferred ML model, and may be more and/or most capable of and/or suitable for processing input data 302 given the conditions under which processing thereof is to be performed.

Each of ML models 340-344 may be configured to perform a same or similar task. As one example, each respective ML model of ML models 340-344 may include a corresponding large language model (“LLM”) configured to generate outputs based on textual inputs. In some implementations, the corresponding LLM may be a multimodal in that it may be configured to receive as input and/or generate as output data types other than text (e.g., image(s), audio, three-dimensional (“3D”) structures, etc.). As another example, rather than processing textual data, each respective ML model of ML models 340-344 may be configured to perform a particular image processing task, audio processing task, point cloud processing task, and/or a processing task for another type of data.

ML models 340-344 may differ from one another in various aspects, attributes, properties, and/or parameters. For example, ML models 340-344 may differ from one another in size (e.g., as measured by the number of trainable parameters), architecture, data set(s) used for training, logical and/or physical location (e.g., relative to a source of input data 302), data security and/or privacy measures provided and/or available thereto, and/or availability of computing resources for execution thereof, among others. Thus, each of ML models 340-344 may vary in the speed, accuracy, privacy, security, and/or efficiency (among other factors) with which input data 302 is processed thereby to generate corresponding output data. Specifically, input data 302, context data 304, model capabilities 306, system state 308, output data 310, and user settings 312 (collectively “attribute values 302-312”) may include, represent, and/or be used by model selection system 300 to determine one or more attribute values that impact the capability of each of ML models 340-344 for processing input data 302.

In some implementations, ML model 340 may be a client-side ML model located on and configured to be executed by a client device from which input data 302 originates, while ML models 342-344 may be server-side ML models located on and configured to be executed by one or more servers communicatively connected to the client device. Thus, ML model 340 may be smaller and include fewer computational resources available for execution thereof than each of ML models 342-344, while being more secure and offering greater privacy than each of ML models 342-344. Thus, using different ones of ML models 340-344 may be associated with various tradeoffs, and model selection system 300 may be configured to quantify these tradeoffs depending on the input data being processed and the circumstances in which processing thereof is requested.

Accordingly, model selection system 300 may be configured to determine and use attribute values 302-312 to assess the capability of each of ML models 340-344 for processing input data 302. Based on assessing the capability of each of ML models 340-344 for processing input data 302, model selection system 300 may be configured to select one or more of ML models 340-344 for processing input data 302. For example, model selection system 300 may be configured to determine that, given attribute values 302-312, client-side ML model 340 is preferred for processing input data 302 over server-side ML models 342-344. It is to be understood that processing of input data 302 by a ML model may include processing input data 302 along with other inputs related to input data 302, such as context data 304.

### A. Input Data

Input data 302 may include (i) the prompt, query, and/or request to be provided as input to an ML model to cause the ML model to generate corresponding output data and/or (ii) any content, documents, and/or other data provided as part of and/or in association with the prompt, query, and/or request. Thus, input data 302 may alternatively be referred to as a prompt, a query, and/or a request. For example, input data 302 may include (i) a textual prompt and (ii) image data to be used by the ML model in responding to the prompt. Attributes of input data 302 may include a size/complexity, sensitivity/privacy, data type/modality, task type, target latency, and/or similarity to other queries, among others. That is, attributes of input data 302 may include characteristics thereof that are usable to quantify the respective capabilities and/or suitabilities of ML models 340-344 for processing input data 302.

For example, model selection system 300 may be configured to determine, based on input data 302, an input complexity value that represents a size and/or a complexity of input data 302. As one example, the query complexity value may represent a number of input tokens present in input data 302. As another example, the query complexity value may represent a score assigned to input data 302 by an ML model (other than ML models 340-344) configured to determine the complexity of input data 302. Larger and/or more complex input data 302 may favor processing by ML models that are larger, more complex, and/or have access to a larger number of computing resources.

Model selection system 300 may also be configured to determine, based on input data 302, an input sensitivity value representing an extent of sensitive content present in input data 302. For example, model selection system 300 may include an ML-based sensitivity model configured to generate a sensitivity score that indicates the amount and/or extent of sensitive data present in input data 302. Examples of data that may be considered sensitive include personally identifiable information (“PII”), health information, and/or biometric information, among others. Sensitive data may favor processing by ML model(s) that are capable of offering sufficient privacy and/or security protections to such data, while input data that is not sensitive may be processed by any of ML models 340-344. For example, highly sensitive input data may favor processing by a client-side ML model over a server-side ML model, since this input data and the output corresponding thereto may remain on the client device, thus avoiding any potential privacy and/or security flaws associated with the server-side ML model, the server server(s) on which the server-side ML model is executed, and/or transmission(s) between the client device and the server(s).

Model selection system 300 may additionally be configured to determine, based on input data 302, an input data type value representing a type of input data 302. For example, the input data type value may indicate that input data 302 includes text, image(s), audio, 3D models, and/or other types of data. The input data type value may be determined, for example, using the file type indicators (e.g., file extensions) associated with input data 302. ML models that are incapable of processing input data 302 having the input data type may be precluded from processing input data 302, while models that are capable of and/or specialized for processing the input data type may be favored.

Model selection system 300 may yet additionally be configured to determine, based on input data 302, a task type value representing a task requested to be performed in connection with input data 302. For example, the task may include generation of text (e.g., answering a question), generation of an image (e.g., as described using text), and/or generation of an assistant action, among other possibilities. The task type value may be based on classification of input data 302 and/or keywords present therein, among other possibilities. ML models that are incapable of performing the requested task may be precluded from processing input data 302, while models that are capable of and/or specialized for the requested task type may be favored.

Model selection system 300 may further be configured to determine, based on input data 302, an output latency value representing a latency with which output data corresponding to input data 302 is expected (e.g., by the requester providing input data 302) to be provided. For example, the latency may be determined based on the topic and/or subject of input data 302, with some topics/subjects being more time-sensitive than others. For example, sensor data relating to operation (e.g., real-time operation) of a robotic device may be expected to be processed faster than a textual prompt for generating an image. Other examples of low-latency tasks include a speech-based conversation (e.g., occurring substantially in real-time) between a user and the respective ML model, operation of an autonomous vehicle (e.g., car, aerial vehicle, etc.), content generation for augmented reality (AR) and/or virtual reality (VR) applications, and/or capture-time photo editing and/or filtering. Thus, low-latency queries may favor low-latency ML models, while latency-tolerant queries may be processed by any ML model.

Model selection system 300 may additionally be configured to determine, based on input data 302, an input similarity value representing a similarity of input data 302 to prior input data provided to one or more of ML models 340-344. For example, an ML model may be used to generate a respective embedding vector for input data 302 and for each of the prior input data, and respective distances between these embedding vectors may be used to quantify the similarity of input data 302 to the prior input data. In cases where input data 302 is similar to a prior query, the ML model that processed the prior query may rely on prompt caching to generate corresponding output data faster and/or more efficiently, thus favoring the ML model that processed the prior query over ML models that did not process sufficiently similar prior queries.

### B. Context Data

Context data 304 may include any data available to a respective ML model of ML models 340-344 in connection with processing input data 302, other than input data 302 itself. For example, context data 304 may include prior input data provided to the respective ML model, prior output data generated by the respective ML model based on the prior input data, intermediate results generated by the respective ML model, and/or any other data sources that may be accessible to the respective ML model. Each respective ML model of ML models 340-344 may be associated with a corresponding model-specific context data, since the corresponding usage histories of ML models 340-344 may differ from one another. Thus, context data 304 may include the corresponding model-specific context data for each respective ML model of ML models 340-344. Attributes of context data 304 may include a size/complexity, sensitivity/privacy, data type/modality, and/or location/availability, among others. That is, attributes of context data 304 may include characteristics thereof that are usable to quantify the respective capabilities and/or suitabilities of ML models 340-344 for processing input data 302.

For example, model selection system 300 may be configured to determine, for each respective ML model and based on context data 304, a context complexity value that represents a size and/or a complexity of the corresponding model-specific context data. The query complexity value may be determined in the same or similar manner as the input complexity value, albeit based on context data 304 rather than input data 302. Larger and/or more complex context data 304 may favor processing by ML models that are larger, more complex, and/or have access to a larger number of computing resources.

Model selection system 300 may also be configured to determine, for each respective ML model and based on context data 304, a context sensitivity value representing an extent of sensitive content present in the corresponding model-specific context data. The context sensitivity value may be determined in the same or similar manner as the input sensitivity value, albeit based on context data 304 rather than input data 302. Sensitive data may favor processing by ML model(s) that are capable of offering sufficient privacy and/or security protections to such data, while input data that is not sensitive may be processed by any of ML models 340-344.

Model selection system 300 may additionally be configured to determine, for each respective ML model and based on context data 304, a context data type value representing a type of the corresponding model-specific context data. For example, the context data type value may indicate that the corresponding model-specific context data includes text, image(s), audio, 3D models, and/or other types of data. The context data type value may be determined in the same or similar manner as the input data type value, albeit based on context data 304 rather than input data 302. ML models that are incapable of processing context data 304 having the context data type may be precluded from processing input data 302, while models that are capable of and/or specialized for processing the context data type may be favored.

Model selection system 300 may further be configured to determine, for each respective ML model and based on context data 304, a context availability value representing availability of the corresponding model-specific context data to the respective ML model. For example, the context availability value may indicate whether the respective ML model has access to the corresponding model-specific context data generated by the respective ML model in connection with relevant prior input data (e.g., input data processed within a threshold time of the current request). Additionally or alternatively, the context availability value may indicate whether the respective ML model has access to corresponding model-specific context data generated by other ML models in connection with relevant prior input data. In some cases, the context availability value may additionally or alternatively be expressed using a context location value that indicates which ML model(s) of ML models 340-344 include context data that is relevant for processing of input data 302. A given ML model of ML models 340-344 may be favored when it previously generated context data 304 and/or can access context data 304 generated by another ML model, and may be precluded from processing input data when it cannot access context data 304.

### C. Model Capabilities

Model capabilities 306 may represent the functions and/or operations that are performable by each respective ML model of ML models 340-344, and may include metrics indicative of a technical performance of the respective ML model in connection with performing these functions and/or operations. For example, each respective ML model of ML models 340-344 may be associated with a corresponding model-specific capability data that represents the types of inputs and/or contexts that the respective ML model is configured to process, the types of tasks that the respective ML model is configured to perform, any security and/or privacy protections offered by the respective ML model, a size and/or complexity of the respective ML model (e.g., measured in number of trainable parameters), various metrics that describe the performance (e.g., speed, accuracy, latency, etc.) of the respective ML model, and/or any other metrics that may be used to determine and/or quantify the respective ML model's ability to process input data 302. Thus, model capabilities 306 may include the corresponding model-specific capability data for each respective ML model of ML models 340-344.

### D. System State

System state 308 may represent the state of computing resources available to each respective ML model of ML models 340-344. System state 308 may pertain to processing resources, memory resources, cache resources, network resources, and/or energy resources, among others.

For example, model selection system 300 may be configured to determine, for each respective ML model of ML models 340-344 and based on system state 308, a memory presence value representing whether the respective ML model has been preloaded into memory (e.g., as part of a prior query/request) before input data 302 is obtained and/or processed. For example, the memory presence value may indicate that the respective ML model (or at least part thereof, e.g., in the case of low-rank adaptation (LoRA) models) is already loaded in memory as a result of a prior execution of the respective ML model, and thus input data 302 can be processed by the respective ML model without waiting for it to be loaded into memory, thereby potentially reducing the latency with which corresponding output data is generated. Accordingly, an ML model that has been preloaded into memory may be favored over another ML model that has not been preloaded into memory.

Model selection system 300 may also be configured to determine, for each respective ML model of ML models 340-344 and based on system state 308, a context cache value representing whether context data 304 is available in a cache memory associated with the respective ML model. For example, the context cache value may indicate that the respective ML model has been used to process prior input data and thus has access to context data 304 resulting therefrom, and/or the respective ML model has been updated using context data 304 generated using another ML model. The cache context value may thus indicate whether processing of input data 302 is dependent on transferring context data 304 and/or portions thereof to the respective ML model from one or more other ML models. Accordingly, the respective ML model may be favored when the cache used thereby includes context data 304, and may be precluded from processing input data 302 when the respective ML model does not have access to context data 304.

Model selection system 300 may additionally be configured to determine, for each respective ML model of ML models 340-344 and based on system state 308, a query cache value representing whether prior input data is available in the cache memory associated with the respective machine learning model. When the cache memory of the respective ML model includes the prior input data, the respective ML model may be able to reuse, at least in part, the results of processing the prior input data rather than processing all of input data 302 anew. That is, query caching may allow the respective ML model to process input data faster and/or more efficiently, with the speed and/or efficiency gain increasing as the similarity of input data 302 to the cached prior input data increasing. Accordingly, the respective ML model may be favored when it can take advantage of query caching.

Model selection system 300 may yet additionally be configured to determine, for each respective ML model of ML models 340-344 and based on system state 308, a network availability value representing availability of a network connection to the respective ML model. For example, the network availability value may indicate whether at least one network connection is available for providing input data 302 to the respective ML model and/or obtaining output data from the respective ML model. An ML model may be favored when a network connection thereto is available and/or provides high data transmission speeds, and may be precluded from processing input data 302 when the network connection thereto in unavailable and/or provides low data transmission speeds.

Model selection system 300 may further be configured to determine, for each respective ML model of ML models 340-344 and based on system state 308, a memory availability value representing availability of memory resources for executing the respective ML model. For example, the memory availability value may indicate whether the computing system configured to execute the respective ML model has enough available memory to load the respective ML model, input data 302, context data 304, and/or any other data involved in execution of the respective Ml model. In some cases, the memory availability value may indicate a time at which sufficient memory is expected to be available for the respective ML model (e.g., once the memory is released by other ML models). Thus, the respective ML model may be favored when it has access to sufficient available memory, and may be disfavored when sufficient memory is not available.

Model selection system 300 may yet further be configured to determine, for each respective ML model of ML models 340-344 and based on system state 308, an energy availability value representing an availability of energy for executing the respective ML model. As one example, the energy availability value may indicate whether a battery of a computing device on which the respective ML model is to be executed includes sufficient charge to execute the respective ML model as requested. As another example, the energy availability value may indicate a cost of energy (e.g., $/kWh) to the computing device on which the respective ML model is to be executed. Thus, a respective ML model may be favored when it has access to sufficient battery power and/or when the cost of grid power is relatively low, and may be disfavored when it does not have access to sufficient battery power and/or when the cost of grid power is relatively high.

Model selection system 300 may be configured to determine, for each respective ML model of ML models 340-344 and based on system state 308, a hardware availability value representing an availability of processing hardware for accelerating execution of the respective ML model. For example, the processing hardware may include a tensor processing unit (TPU), such as the GOOGLE Tensor System-on-chip (SoC) processor, configured to process tensor data using hardware components (e.g., rather than using software executing on a general-purpose processor). For example, the hardware availability value may represent a type of processing hardware available, may indicate whether this processing hardware offers hardware acceleration, and/or may indicate a throughput and/or latency provided by this processing hardware.

### E. Output Data

Output data 310 may represent (i) the results of prior executions of one or more of ML models 340-344 based on processing prior input data and/or (ii) attributes of the expected output of one or more of ML models 340-344 based on processing input data 302. Attributes of output data 310 may pertain to size/complexity, sensitivity, latency, quality/acceptability, and/or execution successes/failures, among others.

For example, model selection system 300 may be configured to determine, based on output data 310, input data 302, and/or context data 304 (among others), an output size value representing a size and/or complexity of output data expected to be generated based on input data 302. The output size value may represent, for example, a number of output tokens expected to be present in the output data expected to be generated based on input data 302. For example, the output size may be predicted using an ML model that has been trained to estimate the output size and/or complexity for input data of various lengths. As another example, the output size may be determined based on a multiple (e.g., a 0.5×, 1×, 1.5×, 2×, 2.5×, etc.) of the size and/or complexity of input data 302 and/or context data 304. Larger and/or more complex output data may favor ML models that are larger, more complex, and/or have access to a larger number of computing resources.

Model selection system 300 may also be configured to determine an output sensitivity value indicating whether output data generated by a first ML model of ML models 340-344 based on processing input data 302 is unsafe, and therefore should be verified by processing input data 302 again using another ML model of ML models 340-344. For example, for output data that does not include private and/or sensitive content, the output sensitivity value may indicate that verification by another ML model is not suggested, since the output data does not include any sensitive content. For output data that includes private and/or sensitive content, the output sensitivity value may indicate that verification by another ML model is suggested to verify the safety and/or bias of the output data before the output data is provided to a user. Thus, sensitive and/or private output data may favor reprocessing by an ML model capable of verifying the safety, bias, and/or other properties thereof.

Model selection system 300 may additionally be configured to determine, for each respective ML model of ML models 340-344 and based on output data 310, a latency history value representing a latency with which the respective ML model provided one or more prior output data based on one or more prior input data. For example, the latency history value may indicate that the respective ML model takes a relatively long time to respond to queries due to, for example, receiving an above-average number of queries. The latency history value may represent, for example, an average latency across a predetermined number of prior processing iterations by the respective ML model. Input data 302 expected to be processed with relatively low latency may favor selection of an ML model capable of providing output with a commensurate latency.

Model selection system 300 may yet additionally be configured to determine an output acceptability value representing whether a respective ML model of ML models 340-344 provided unacceptable output data based on a prior attempt at processing input data 302. For example, the output acceptability value may indicate that a user is dissatisfied with the output data generated by the respective ML model in connection with the prior attempt at processing input data 302, and thus input data 302 is to be reprocessed by a different ML model of ML models 340-344. The respective ML model may thus be precluded from processing input data 302 when the prior attempt at processing input data by the respective ML model did not produce acceptable output data.

Model selection system 300 may further be configured to determine a query failure value representing whether the respective ML model failed to generate output data based on a prior attempt at processing input data 302. For example, the query failure value may indicate that the respective ML model did not generate any output data as part of the prior attempt, and/or a cause of the failure (e.g., software error, insufficient memory, network failure, etc.) The respective ML model may thus be precluded from processing input data 302 when the prior attempt at processing input data by the respective ML model resulted in a failure to generate output data.

### F. User Settings

User settings 312 may represent various user preferences regarding how input data is processed. User settings 312 may include a user-specified selection and/or ranking of one or more of models 340-344 to be used in responding to queries from a particular user and/or group of users. Additionally or alternatively, user settings 312 may include a user-specified sensitivity value representing a user preference (or lack thereof) for using a particular machine learning model of ML models 340-344 for processing certain types of input data. For example, the user-specified sensitivity value may indicate that input data containing PII is always to be processed by client-side model(s) (which are accessible to a single user), thus indicating that the PII is not to be shared with server-side models that process queries from multiple different users. User settings 312 may, in some cases, specify one or more weights used by model selection system 300 in selecting among models 340-344. These one or more weights may represent the relative importance of different attribute values in model selection. For example, a first user may favor protection of sensitive data over processing speed, while a second user may favor energy efficiency with no regard for processing speed.

### G. Capability Value Calculation

Model selection system 300 may be configured to calculate capability values 336 based on the attribute values of input data 302, context data 304, model capabilities 306, system state 308, output data 310, and/or user settings 312 discussed above. Specifically, technical capability calculator 316, memory capability calculator 320, sensitivity capability calculator 324, latency and retry capability calculator 328, and combined capability calculator 334 may be used to determine capability values 336 based on initial capability values 314 and attribute values 302-312. Capability values 336 may thus quantify the overall capability/suitability of each of ML models 340-344 for processing input data 302 under conditions represented by attribute values 302-312, and may allow for selection of an ML model that is more suited (and/or best suited) for processing input data 302 than other available ML models.

Initial capability values 314 may represent starting values for calculating capability values 336. Initial capability values 314 may include, for each respective ML model of ML models 340-344, at least one corresponding initial capability value. In some implementations, all of initial capability values 314 may be equal to indicate that, before considering any of attribute values 302-312, each of ML models 340-344 is equally suitable for processing input data 302. In other implementations, some of initial capability values 314 may be greater than others to bias model selection system 300 toward selecting some of ML models 340-344 over others. In some cases, initial capability values 314 for the respective ML model of ML models 340-344 may include a corresponding set of initial capability values for each of calculators 316, 320, 324, and 328. That is, each of calculators 316-320, 324, and 328 may be biased in favor of or against the respective ML model to different extents. Initial capability values 314 may be modifiable by user(s), developer(s), and/or administrator(s) of model selection system 300 to indicate a relative preference for one or more of ML models 340-344. In some cases, one or more of initial capability values 314 may be specified as part of and/or determined based on user settings 312.

Technical capability calculator 316 may determine technical capability values 318 based on initial capability values 314 and one or more technical performance values that represent a first subset of attribute values 302-312. The one or more technical performance values may relate to and/or represent a technical capability of a respective ML model of ML models 340-344 for processing of input data 302. The one or more technical performance values may include, for example, the task type value, the input data type value, the context data type value, the output data type value, the input complexity value, the context complexity value, the output complexity value, the network availability value, and/or the energy availability value, as discussed above.

Technical capability calculator 316 may implement the function

$${C}_{i}^{tech} = {I}_{i}^{tech} * {f}_{tech}^{1} ( {T}_{i}^{1} , {W}_{tech}^{1} ) ... * ... {f}_{tech}^{j} ( {T}_{i}^{j} , {W}_{tech}^{j} ) , where {C}_{i}^{tech}$$

represents the ith technical capability value of technical capability values 318 and corresponds to the ith ML model of ML models 340-344,

$${I}_{i}^{tech}$$

represents the ith initial capability value of initial capability values 314 for the ith ML model (

$${I}_{i}^{tech}$$

may be omitted in some implementations),

$${T}_{i}^{k}$$

(where 1≤k≤j) represents the kth technical performance value of the one or more technical performance values and corresponds to the ith ML model,

$${W}_{tech}^{k}$$

represents a weight (e.g., which may be predetermined) assigned to the kth technical performance value, and

$${f}_{tech}^{k}$$

represents a function applied to the kth technical performance value and its corresponding weight. Because

$${C}_{i}^{tech}$$

is based on the one or more technical performance values,

$${C}_{i}^{tech}$$

may quantify a technical capability of the ith ML model for processing input data 302 under conditions represented by attribute values 302-312.

The function

$${f}_{tech}^{k} ( )$$

may include one or more conditions that may be applied to and/or based on the kth technical performance value

$${T}_{i}^{k} .$$

For example, the function

$${f}_{tech}^{k} ( )$$

may check whether

$${T}_{i}^{k}$$

is equal to a particular value, is greater than the particular value, and/or is less than the particular value, among other possibilities. Specifically, when the value of

$${T}_{i}^{k}$$

favors selection of the ith ML model (e.g., when

$${T}_{i}^{k}$$

meets a first (positive) condition specified by

$${f}_{tech}^{k} ( ) ,$$

or when

$${T}_{i}^{k}$$

does not meet a second (negative) condition specified by

$${f}_{tech}^{k} ( ) ) ,$$

the output of

$${f}_{tech}^{k} ( {T}_{i}^{k} , {W}_{tech}^{k} )$$

may be greater than one, and thus

$${C}_{i}^{tech}$$

may be increased by the output of

$${f}_{tech}^{k} ( {T}_{i}^{k} , {W}_{tech}^{k} ) .$$

When the value of

$${T}_{i}^{k}$$

disfavors selection of the ith ML model (e.g., when

$${T}_{i}^{k}$$

does not meet the first (positive) condition specified by

$${f}_{tech}^{k} ( ) ,$$

or when

$${T}_{i}^{k}$$

meets the second (negative) condition specified by

$${f}_{tech}^{k} ( ) ) ,$$

the output of

$${f}_{tech}^{k} ( {T}_{i}^{k} , {W}_{tech}^{k} )$$

may be less than one, and thus

$${C}_{i}^{tech}$$

may be decreased by the output of

$${f}_{tech}^{k} ( {T}_{i}^{k} , {W}_{tech}^{k} ) .$$

When the value of

$${T}_{i}^{k}$$

is neutral with respect to (i.e., neither favors nor disfavors) selection of the ith ML model, the output of tech

$$( {T}_{i}^{k} , {W}_{tech}^{k} )$$

may be equal to one, and thus

$${C}_{i}^{tech}$$

may be unaffected by

$${f}_{tech}^{k} ( {T}_{i}^{k} , {W}_{tech}^{k} ) .$$

As one example, when the value of

$${T}_{i}^{k}$$

favors selection of the ith ML model, the output of

$${f}_{tech}^{k} ( {T}_{i}^{k} , {W}_{tech}^{k} )$$

may be

$${W}_{tech}^{k} , where {W}_{tech}^{k} > 1 ,$$

and thus Iᵢ may be increased through multiplication by

$${W}_{tech}^{k} .$$

As another example, when the value of

$${T}_{i}^{k}$$

disfavors selection of the ith ML model, the output of

$${f}_{tech}^{k} ( {T}_{i}^{k} , {W}_{tech}^{k} )$$

may be

$${W}_{tech}^{k} , where {W}_{tech}^{k} < 1 ,$$

and thus Iᵢ may be decreased through multiplication by

$${W}_{tech}^{k} .$$

### Accordingly,

$${C}_{i}^{tech}$$

may be increased (when

$${W}_{tech}^{k} > 1 )$$

or decreased (when

$${W}_{tech}^{k} < 1 )$$

according to the value of

$${W}_{tech}^{k}$$

to reflect how the value of

$${T}_{i}^{k}$$

affects the capability of the ith ML model for processing input data 302. As a further example, when the value of

$${T}_{i}^{k}$$

precludes selection of the ith ML model, the output of

$${f}_{tech}^{k} ( {T}_{i}^{k} , {W}_{tech}^{k} )$$

may be equal to zero, and thus

$${C}_{i}^{tech}$$

may be reduced to 0 by

$${f}_{tech}^{k} ( {T}_{i}^{k} , {W}_{tech}^{k} ) .$$

In some implementations,

$${f}_{tech}^{k} ( )$$

may be configured to receive as input and process multiple technical performance values. For example,

$${f}_{tech}^{k} ( )$$

may be a function of both

$${T}_{i}^{k} and {T}_{i}^{m} or {f}_{tech}^{k} ( )$$

may be a function of

$${T}_{i}^{k} and {T}_{i}^{m} , ... , {T}_{i}^{n} ,$$

where 1≤m≤j and 1≤n≤j. The function

$${f}_{tech}^{k} ( )$$

may, for example, determine whether the kth ML model is capable of providing a level of performance

$$( e . g . , {T}_{i}^{k} )$$

necessitated by one or more attributes

$$( e . g . , {T}_{i}^{m} , ... , {T}_{i}^{n} )$$

of input data 302. Thus,

$${f}_{tech}^{k} ( )$$

may include one or more conditions that account for and/or are based on a plurality of technical performance values.

As an example, when

$${T}_{i}^{1}$$

represents the task type value,

$${f}_{tech}^{1} ( {T}_{i}^{1} , {W}_{tech}^{1} )$$

may return (i) 0 when the ith ML model is not capable of performing the task represented by the task type value, (ii) 1 when the ith ML model is capable of performing this task, and (iii)

$${W}_{tech}^{1} > 1$$

when the ith ML model is specialized in (e.g., better than alternative ML models) performing this task. When

$${T}_{i}^{2}$$

represents the input data type value,

$${f}_{tech}^{2} ( {T}_{i}^{2} , {W}_{tech}^{2} )$$

may return (i) 0 when the ith ML model is not capable of processing the type of input data represented by the input data type value, (ii) 1 when the ith ML model is capable of processing this type of input data, and (iii)

$${W}_{tech}^{2} > 1$$

when the ith ML model is specialized in processing this type of input data. Similarly,

$${f}_{tech}^{3} ( {T}_{i}^{3} , {W}_{tech}^{3} ) and {f}_{tech}^{4} ( {T}_{i}^{4} , {W}_{tech}^{4} )$$

may return commensurate results when

$${T}_{i}^{3} and {T}_{i}^{4}$$

represent, respectively, the context data type value and the output data type value.

When

$${T}_{i}^{5}$$

represents the input complexity value,

$${f}_{tech}^{5} ( {T}_{i}^{5} , {W}_{tech}^{5} )$$

may return (i) 0 when the input complexity exceeds the capability of the ith ML model (e.g., the input complexity value is above a first complexity threshold value for the ith ML model), (ii) 1 when the input complexity matches the capability of the ith ML model (e.g., the input complexity value is below the first complexity threshold value and above a second complexity threshold value for the ith ML model), and (iii)

$${W}_{tech}^{5} > 1$$

when the input complexity is exceeded by the capability of the ith ML model (e.g., the input complexity value is below the second complexity threshold value). Similarly,

$${f}_{tech}^{6} ( {T}_{i}^{6} , {W}_{tech}^{6} ) and {f}_{tech}^{7} ( {T}_{i}^{7} , {W}_{tech}^{7} )$$

may return commensurate results when

$${T}_{i}^{6} and {T}_{i}^{7}$$

represent, respectively, the context complexity value and the output complexity value.

When

$${T}_{i}^{8}$$

represents the network availability value,

$${f}_{tech}^{8} ( {T}_{i}^{8} , {W}_{tech}^{8} )$$

may return (i) 0 when a network connection (e.g., from a source of input data 302) to the ith ML model is not available, (ii) 1 when the network connection is available and provides less than a threshold speed, and (iii)

$${W}_{tech}^{8} > 1$$

when the network connection is available and provides more than the threshold speed. Whe

$${T}_{i}^{9}$$

represents the energy availability value,

$${f}_{tech}^{9} ( {T}_{i}^{9} , {W}_{tech}^{9} )$$

may return (i) 0 when an amount of energy and/or power available for execution of the ith ML model (e.g., in a battery of the client device, or in a power grid supplying the server device) is less than a first energy/power threshold, (ii) 1 when the amount of energy and/or power exceeds the first energy/power threshold but does not exceed a second energy/power threshold, and (iii)

$${W}_{tech}^{9} > 1$$

when the amount of energy and/or power exceeds both the first energy/power threshold and the second energy/power threshold. When

$${T}_{i}^{10}$$

represents the hardware availability value,

$${f}_{tech}^{10} ( {T}_{i}^{10} , {W}_{tech}^{10} )$$

may return (i) 1 when hardware acceleration is not available for execution of the ith ML model and (ii)

$${W}_{tech}^{10} > 1$$

when hardware acceleration is available for execution of the ith ML model.

Memory capability calculator 320 may determine memory capability values 322 based on one or more memory state values that represent a second subset of attribute values 302-312. The one or more memory state values may relate to and/or represent a state of memory resources available to a respective ML model of ML models 340-344 for processing of input data 302. The one or more memory state values may include, for example, the memory availability value, the memory presence value, the context availability value, the context cache value, the input similarity value, and/or the query cache value, as discussed above.

Memory capability calculator 320 may implement the function

$${C}_{i}^{m e m} = {I}_{i}^{mem} * {f}_{mem}^{1} ( {M}_{i}^{1} , {W}_{mem}^{1} ) … * … {f}_{mem}^{j} ( {M}_{i}^{j} , {W}_{mem}^{j} ) ,$$

$$where$$

$${C}_{i}^{mem}$$

represents the ith memory capability value of memory capability values 322 and corresponds to the ith ML model of ML models 340-344,

$${I}_{i}^{mem}$$

represents the ith initial capability value of initial capability values 314 for the ith ML model (

$${I}_{i}^{mem}$$

may be omitted in some implementations),

$${M}_{i}^{k}$$

(where 1≤k≤j) represents the kth memory state value of the one or more memory state values and corresponds to the ith ML model,

$${W}_{mem}^{k}$$

represents a weight (e.g., which may be predetermined) assigned to the kth memory state value, and

$${f}_{mem}^{k}$$

represents a function applied to the kth memory state value and its corresponding weight. Because

$${C}_{i}^{m e m}$$

is based on the one or more memory state values,

$${C}_{i}^{m e m}$$

may quantify a capability of the memory resources to facilitate execution of ith ML model and/or processing of input data 302 thereby under conditions represented by the attribute values.

The function

$${f}_{mem}^{k} ( )$$

may be similar to the function

$${f}_{tech}^{k} ( )$$

as described above, but may be applied with respect to the memory state value(s) rather than the technical performance value(s). For example, the function

$${f}_{mem}^{k} ( )$$

may include one or more conditions that may be applied to and/or based on the kth memory state value

$${M}_{i}^{k} .$$

Specifically, when the value of

$${M}_{i}^{k}$$

favors selection of the ith ML model (e.g., when

$${M}_{i}^{k}$$

meets a third (positive) condition specified by

$${f}_{mem}^{k} ( ) ,$$

or when

$${M}_{i}^{k}$$

does not meet a fourth (negative) condition specified by

$${f}_{mem}^{k} ( ) ) ,$$

the output of

$${f}_{mem}^{k} ( {M}_{i}^{k} , {W}_{mem}^{k} )$$

may be greater than one

$$( e . g . , {W}_{mem}^{k} , where {W}_{mem}^{k} > 1 ) ,$$

and thus

$${C}_{i}^{mem}$$

may be increased by the output of

$${f}_{mem}^{k} ( {M}_{i}^{k} , {W}_{mem}^{k} ) .$$

When the value of

$${M}_{i}^{k}$$

disfavors selection of the ith ML model (e.g., when

$${M}_{i}^{k}$$

does not meet the third (positive) condition specified by

$${f}_{mem}^{k} ( ) ,$$

or when

$${M}_{i}^{k}$$

meets the fourth (negative) condition specified by

$${f}_{mem}^{k} ( ) ) ,$$

the output of

$${f}_{mem}^{k} ( {M}_{i}^{k} , {W}_{mem}^{k} )$$

may be less than one

$$( e . g . , {W}_{mem}^{k} , where {W}_{mem}^{k} < 1 , or 0 ) ,$$

and thus

$${C}_{i}^{mem}$$

may be decreased by the output of

$${f}_{mem}^{k} ( {M}_{i}^{k} , {W}_{mem}^{k} ) .$$

When the value of

$${M}_{i}^{k}$$

is neutral with respect to (i.e., neither favors nor disfavors) selection of the ith ML model, the output of

$${f}_{mem}^{k} ( {M}_{i}^{k} , {W}_{mem}^{k} )$$

may be equal to one, and thus

$${C}_{i}^{mem}$$

may be unaffected by

$${f}_{mem}^{k} ( {M}_{i}^{k} , {W}_{mem}^{k} ) .$$

As an example, when

$${M}_{i}^{1}$$

represents the memory availability value,

$${f}_{mem}^{1} ( {M}_{i}^{1} , {W}_{mem}^{1} )$$

may return (i) 0 when the amount of memory available for execution of the ith ML model is less than a first memory threshold value (e.g., insufficient to load the ith ML model into memory), (ii) 1 when the amount of memory available for execution of the ith ML model is greater than the first memory threshold value and less than a second memory threshold value (e.g., sufficient to load the ith ML model into memory along with a moderate amount of input data), and (iii)

$${W}_{mem}^{1} > 1$$

when the amount of memory available for execution of the ith ML model is greater than the second memory threshold value (e.g., sufficient to load the ith ML model into memory along with a relatively large amount of input data).

When

$${M}_{i}^{2}$$

represents the memory presence value,

$${f}_{mem}^{2} ( {M}_{i}^{2} , {W}_{mem}^{2} )$$

may return (i)

$${W}_{mem}^{2} < 1$$

when the ith ML model has not been preloaded into memory and (ii) 1 or

$${W}_{mem}^{2} > 1$$

when the ith ML model has been preloaded into memory. When

$${M}_{i}^{3}$$

represents the context availability value,

$${f}_{mem}^{3} ( {M}_{i}^{3} , {W}_{mem}^{3} )$$

may return (i) 0 when context data 304 is not available to ith ML model and (ii) 1 when context data 304 is available to ith ML model (e.g., either present on the same computing device as ith model or obtainable by the ith ML model from another computing device). When

$${M}_{i}^{4}$$

represents the context cache value,

$${f}_{mem}^{4} ( {M}_{i}^{4} , {W}_{mem}^{4} )$$

may return (i) 1 when context data 304 is not present in cache memory of the computing device configured to execute the ith ML model and (ii)

$${W}_{mem}^{4} > 1$$

when context data 304 is present in the cache memory of the computing device configured to execute the ith ML model.

When

$${M}_{i}^{5}$$

represents the input similarity value,

$${f}_{mem}^{5} ( {M}_{i}^{5} , {W}_{mem}^{5} )$$

may return (i) 1 when a similarity between input data 302 prior input data processed by the ith ML model is less than a threshold similarity value and (ii)

$${W}_{mem}^{5} > 1$$

when the similarity exceeds the threshold similarity value (e.g., which may allow the ith ML model to take advantage of prompt caching). When

$${M}_{i}^{6}$$

represents the query cache value,

$${f}_{mem}^{6} ( {M}_{i}^{6} , {W}_{mem}^{6} )$$

may return (i) 1 when the prior input data is not available in the cache memory associated with the ith ML model and (ii)

$${W}_{mem}^{6} > 1$$

when the prior input data is available in the cache memory associated with the ith ML model (e.g., thus facilitating prompt caching).

Sensitivity capability calculator 324 may determine sensitivity capability values 326 based on one or more sensitivity values that represent a third subset of the attribute values. The one or more sensitivity values may relate to and/or represent a sensitivity associated with processing of input data 302. The one or more sensitivity values may include, for example, the user-specified sensitivity value, the input sensitivity value, the context sensitivity value, and/or the output sensitivity value, as discussed above.

Sensitivity capability calculator 324 may implement the function

$${C}_{i}^{sens} = {I}_{i}^{sens} * {f}_{sens}^{1} ( {S}_{i}^{1} , {W}_{sens}^{1} ) ... * ... {f}_{sens}^{j} ( {S}_{i}^{j} , {W}_{sens}^{j} ) ,$$

where

$${C}_{i}^{sens}$$

represents the ith sensitivity capability value of sensitivity capability values 326 and corresponds to the ith ML model of ML models 340-344,

$${I}_{i}^{sens}$$

represents the ith initial capability value of initial capability values 314 for the ith ML model (

$${I}_{i}^{sens}$$

may be omitted in some implementations),

$${S}_{i}^{k}$$

(where 1≤k≤j) represents the kth sensitivity value of the one or more sensitivity values and corresponds to the ith ML model,

$${W}_{sens}^{k}$$

represents a weight (e.g., which may be predetermined) assigned to the kth sensitivity value, and

$${f}_{sens}^{k} ( )$$

represents a function applied to the kth sensitivity value and its corresponding weight. Because

$${C}_{i}^{sens}$$

is based on the one or more sensitivity values,

$${C}_{i}^{sens}$$

may quantify a capability of the ith ML model for securely processing input data 302 under conditions represented by attribute values 302-312.

The function

$${f}_{sens}^{k} ( )$$

may be similar to the function

$${f}_{tech}^{k} ( )$$

and/or the function

$${f}_{mem}^{k} ( )$$

as described above, but may be applied with respect to the sensitivity value(s) rather than the technical performance value(s) and/or the memory state value(s). For example, the function

$${f}_{sens}^{k} ( )$$

may include one or more conditions that may be applied to and/or based on the kth sensitivity value

$${S}_{i}^{k} .$$

Specifically, when the value of

$${S}_{i}^{k}$$

favors selection of the ith ML model (e.g., when

$${S}_{i}^{k}$$

meets a fifth (positive) condition specified by

$${f}_{sens}^{k} ( ) ,$$

or when

$${S}_{i}^{k}$$

does not meet a sixth (negative) condition specified by

$${f}_{sens}^{k} ( ) ) ,$$

the output of

$${f}_{sens}^{k} ( {S}_{i}^{k} , {W}_{sens}^{k} )$$

may be greater than one

$$( e . g . , {W}_{sens}^{k} , where {W}_{sens}^{k} > 1 ) ,$$

and thus

$${C}_{i}^{sens}$$

may be increased by the output of

$${f}_{sens}^{k} ( {S}_{i}^{k} , {W}_{sens}^{k} ) .$$

When the value of

$${S}_{i}^{k}$$

disfavors selection of the ith ML model (e.g., when

$${S}_{i}^{k}$$

does not meet the fifth (positive) condition specified by

$${f}_{sens}^{k} ( ) ,$$

or when

$${S}_{i}^{k}$$

meets the sixth (negative) condition specified by

$${f}_{sens}^{k} ( ) ) ,$$

the output of

$${f}_{sens}^{k} ( {S}_{i}^{k} , {W}_{sens}^{k} )$$

may be less than one (e.g.,

$${W}_{sens}^{k} ,$$

where

$${W}_{sens}^{k} < 1 , or 0 ) ,$$

and thus

$${C}_{i}^{sens}$$

may be decreased by the output of

$${f}_{sens}^{k} ( {S}_{i}^{k} , {W}_{sens}^{k} ) .$$

When the value of

$${S}_{i}^{k}$$

is neutral with respect to (i.e., neither favors nor disfavors) selection of the ith ML model, the output of

$${f}_{sens}^{k} ( {S}_{i}^{k} , {W}_{sens}^{k} )$$

may be equal to one, and thus

$${C}_{i}^{sens}$$

may be unaffected by

$${f}_{sens}^{k} ( {S}_{i}^{k} , {W}_{sens}^{k} ) .$$

As an example, when

$${S}_{i}^{1}$$

represents the user-specified sensitivity value,

$${f}_{sens}^{1} ( {S}_{i}^{1} , {W}_{sens}^{1} )$$

may return (i) 0 when the user-specified sensitivity value indicates that the ith ML model is precluded from processing input data 302 and/or certain types of input data, (ii) 1 when the user-specified sensitivity value indicates that the user is indifferent about using the ith ML model, and (iii)

$${W}_{sens}^{1} > 1$$

when the user-specified sensitivity value indicates a preference for the ith ML model (e.g.,

$${W}_{sens}^{1}$$

may be used indicate a magnitude of this preference).

When

$${S}_{i}^{2}$$

represents the input sensitivity value,

$${f}_{sens}^{2} ( {S}_{i}^{2} , {W}_{sens}^{2} )$$

may return (i) 0 when the ith ML model is incapable of offering sufficient privacy and/or security protections to input data 302 (e.g., when the input sensitivity value exceeds a first model-specific sensitivity threshold value), (ii) 1 when the ith ML model is capable of offering moderate privacy and/or security protections to input data 302 (e.g., when the input sensitivity value is lower than the first model-specific sensitivity threshold value and exceeds a second model-specific sensitivity threshold value), and (iii)

$${W}_{sens}^{2} > 1$$

when the ith ML model is capable of offering high security and/or protections to input data 302 (e.g., when the input sensitivity value is lower than both the first model-specific sensitivity threshold value and the second model-specific sensitivity threshold value). Similarly,

$${f}_{sens}^{3} ( {S}_{i}^{3} , {W}_{sens}^{3} )$$

may return similar results when

$${S}_{i}^{3}$$

represents the context sensitivity value.

When

$${S}_{i}^{4}$$

represents the output sensitivity value,

$${f}_{sens}^{4} ( {S}_{i}^{4} , {W}_{sens}^{4} )$$

may return (i) 0 when the ith ML model previously generated output data that has been determined to be unsafe and another ML model is available to more accurately assess the safety of this output data, (ii) 1 or

$${W}_{sens}^{4} > 1$$

when the ith ML model is configured to assess the safety of output data that has been generated by another ML model and determined to be unsafe.

Latency and retry capability calculator 328 may determine capability values 336 based on (i) one or more latency values that represent a fourth subset of attribute values 302-312 and/or (ii) one or more query retry values that represent a fifth subset of attribute values 302-312. The one or more latency values may relate to and/or represent a latency associated with processing of input data 302 by a respective ML model of ML models 340-344. The one or more latency values may include, for example, the target latency value and/or the latency history value, as discussed above. The one or more query retry values may relate to and/or represent results of a prior attempt at processing of input data 302 by the respective ML model of ML models 340-344. The one or more query retry values may include, for example, the output acceptability value and/or the query failure value, as discussed above.

Latency and retry capability calculator 328 may implement the function

$${C}_{i}^{l \& r} = {I}_{i}^{l \& r} * {f}_{l \& r}^{1} ( {L}_{i}^{1} , {W}_{l \& r}^{1} ) ... * ... {f}_{l \& r}^{j} ( {L}_{i}^{j} , {W}_{l \& r}^{j} ) , where {C}_{i}^{l \& r}$$

represents the ith capability value of latency and retry capability values 330 and corresponds to the ith ML model of ML models 340-344,

$${I}_{i}^{l \& r}$$

represents the ith initial capability value of initial capability values 314 for the ith ML model,

$${L}_{i}^{k}$$

(where 1≤k≤j) represents the kth latency/retry value of the one or latency values and the one or more query retry values and corresponds to the ith ML model,

$${W}_{l \& r}^{k}$$

represents a weight (e.g., which may be predetermined) assigned to the kth latency/retry value, and

$${f}_{l \& r}^{k}$$

represents a function applied to the kth latency/retry value and its corresponding weight. Because

$${C}_{i}^{l \& r}$$

is based on the one or more latency values,

$${C}_{i}^{l \& r}$$

may quantify a latency associated with processing input data 302 by the ith ML model under conditions represented by attribute values 302-312. Additionally, because

$${C}_{i}^{l \& r}$$

based on the one or more query retry values,

$${C}_{i}^{l \& r}$$

may quantify a likelihood of a successful reattempt at processing input data 302 by the ith ML model under conditions represented by attribute values 302-312.

The function

$${f}_{l \& r}^{k} ( )$$

may be similar to the function

$${f}_{tech}^{k} ( ) ,$$

the function

$${f}_{mem}^{k} ( ) ,$$

and/or the function

$${f}_{sens}^{k} ( )$$

as described above, but may be applied with respect to the latency and/or query retry value(s) rather than the technical performance value(s) the memory state value(s), and/or the sensitivity value(s). For example, the function

$${f}_{l \& r}^{k} ( )$$

may include one or more conditions that may be applied to and/or based on the kth latency/retry value

$${L}_{i}^{k} .$$

Specifically, when the value of

$${L}_{i}^{k}$$

favors selection of the ith ML model (e.g., when

$${L}_{i}^{k}$$

meets a seventh (positive) condition specified by

$${f}_{l \& r}^{k} ( ) ,$$

or when

$${L}_{i}^{k}$$

does not meet an eighth (negative) condition specified by

$${f}_{l \& r}^{k} ( ) ) ,$$

the output of

$${f}_{l \& r}^{k} ( {L}_{i}^{k} , {W}_{l \& r}^{k} )$$

may be greater than one

$$( e . g . , {W}_{l \& r}^{k} , where {W}_{l \& r}^{k} > 1 ) ,$$

and thus

$${C}_{i}^{l \& r}$$

may be increased by the output of

$${f}_{l \& r}^{k} ( {L}_{i}^{k} , {W}_{l \& r}^{k} ) .$$

When the value of

$${L}_{i}^{k}$$

disfavors selection of the ith ML model (e.g., when

$${L}_{i}^{k}$$

does not meet the seventh (positive) condition specified by

$${f}_{l \& r}^{k} ( ) ,$$

or when

$${L}_{i}^{k}$$

meets the eighth (negative) condition specified by

$${f}_{l \& r}^{k} ( ) ) ,$$

the output of

$${f}_{l \& r}^{k} ( {L}_{i}^{k} , {W}_{l \& r}^{k} )$$

may be less than one

$$( e . g . , {W}_{l \& r}^{k} , where {W}_{l \& r}^{k} < 1 , or 0 ) ,$$

and thus

$${C}_{i}^{l \& r}$$

may be decreased by the output of

$${f}_{l \& r}^{k} ( {L}_{i}^{k} , {W}_{l \& r}^{k} ) .$$

When the value of

$${L}_{i}^{k}$$

is neutral with respect to (i.e., neither favors nor disfavors) selection of the ith ML model, the output of

$${f}_{l \& r}^{k} ( {L}_{i}^{k} , {W}_{l \& r}^{k} )$$

may be equal to one, and thus

$${C}_{i}^{l \& r}$$

may be unaffected by

$${f}_{l \& r}^{k} ( {L}_{i}^{k} , {W}_{l \& r}^{k} ) .$$

In some implementations, the one or more latency values and the one or more query retry values may be processed by separate calculators of model selection system 300. For example, latency and retry capability calculator 328 may be replaced by a latency capability calculator and a separate query retry capability calculator.

As an example, when

$${L}_{i}^{1}$$

represents the target latency value,

$${f}_{l \& r}^{1} ( {L}_{i}^{1} , {W}_{l \& r}^{1} )$$

may return (i) 1 when the ith ML model is configured and/or expected to generate output data corresponding to input data 302 with more than the target latency value and (ii)

$${W}_{l \& r}^{1} > 1$$

when the ith ML model is configured and/or expected to generate the output data with less than the target latency value. When

$${L}_{i}^{2}$$

represents the output latency history value,

$${f}_{l \& r}^{2} ( {L}_{i}^{2} , {W}_{l \& r}^{2} )$$

may return (i) 1 when the ith ML model has historically (e.g., during a predetermined number of preceding iterations) generated prior output data with more than a threshold historical latency value and (ii)

$${W}_{l \& r}^{1} > 1$$

when the ith ML model has historically generated prior output data with less than the threshold historical latency value.

As another example, when

$${L}_{i}^{3}$$

represents the output acceptability value,

$${f}_{l \& r}^{3} ( {L}_{i}^{3} , {W}_{l \& r}^{3} )$$

may return (i) 1 when the ith ML model generated acceptable output data (e.g., as judged by a user and/or another ML model) based on a prior attempt at processing input data 302 and (ii) 0 when the ith ML model did not generated acceptable output data based on the prior attempt at processing input data 302. When

$${L}_{i}^{4}$$

represents the query failure value,

$${f}_{l \& r}^{4} ( {L}_{i}^{4} , {W}_{l \& r}^{4} )$$

may return (i) 0 when the ith ML model failed to generate any output data based on the prior attempt at processing input data 302 and (ii) 1 when the ith ML model generated at least some output data (regardless of its acceptability/quality) based on the prior attempt at processing input data 302.

Combined capability calculator 334 may be configured to determine capability values 336 based on technical capability values 318, memory capability values 322, sensitivity capability values 326, and/or latency and retry capability values 330. As one example, combined capability calculator may implement the function

$${C}_{i}^{combined} = {C}_{i}^{tech} * {C}_{i}^{mem} * {C}_{i}^{sens} * {C}_{i}^{L \& r} , where {C}_{i}^{combined}$$

represents the ith capability value of capability values 336 and corresponds to the ith ML model of ML models 340-344. That is, capability values 336 may be based on a product of technical capability values 318, memory capability values 322, sensitivity capability values 326, and latency and retry capability values 330. As another example, combined capability calculator may implement the function

$${C}_{i}^{combined} = {C}_{i}^{tech} + {C}_{i}^{mem} + {C}_{i}^{sens} + {C}_{i}^{L \& r} .$$

That is, capability values 336 may be based on a sum of technical capability values 318, memory capability values 322, sensitivity capability values 326, and latency and retry capability values 330.

Model selector 338 may be configured to select, based on capability values 336, at least one of ML models 340-344 by which to process input data 302. For example, model selector 338 may be configured to identify a highest capability value of capability values 336, and identify the ML model associated with the highest capability value. For example, when model selector 338 determines that ML model 342 is associated with a highest capability values of capability values 336, model selector 338 may be configured to route input data 302 (possibly along with other relevant data) to ML model 342 for processing. Thus, model selection system 300 may be configured to provide input data 302 to the ML model that is likely to be most capable and/or suitable for processing input data 302, or at least likely to be more capable and/or better suited than at least one other ML model of ML models 340-344.

In some implementations, including the examples discussed herein, the operations performed by capability calculators 316, 320, 324, and 328 may be commutative. That is, the operations of capability calculators 316, 320, 324, and 328 may be performed in a different order than discussed herein without changing capability values 336. For example, capability calculators 316, 320, 324, and 328 may be arranged sequentially, and the output of a given capability calculator may be provided as input to (e.g., replacing the initial capability values 314 used by) a subsequent capability calculator. Further, although the examples provided herein utilize multiplication to compute capability values 318, 322, 326, and 336, capability values 318, 322, 326, and 330 may additionally or alternatively be determined using addition, among other possible commutative operations. In some implementations, the operations of capability calculators 316, 320, 324, and 328 might not be commutative.

In some implementations, capability calculators 316, 320, 324, 328, and 334 and model selector 338 may be replaced by, structured as, and/or combined with a decision tree. The decision tree may include a plurality of nodes that may be traversed according to attribute values 302-312 to select one of ML models 340-344. Specifically, each respective node of the plurality of nodes may be configured to receive as input at least one attribute value of attribute values 302-312 and, based on the at least one attribute value, select a subsequent node of the plurality of nodes. The subsequent node may also be configured to select a further subsequent node based on at least one other attribute value of attribute values 302-312. Thus, the decision tree may be traversed until arriving at a particular leaf node of a plurality of leaf nodes of the decision tree, where the particular leaf node represents the ML model of ML models 340-344 that is likely to be most capable and/or suitable for processing of input data given attribute values 302-312. In some implementations, the decision tree may be determined by, for example, a programmer, developer, and/or user of model selection system 300. In other implementations, the decision tree may be trained using training data that represents historic performance of ML models 340-344 as a function of various training attribute values corresponding to attribute values 302-312.

### IV. Example Computing Device Architecture

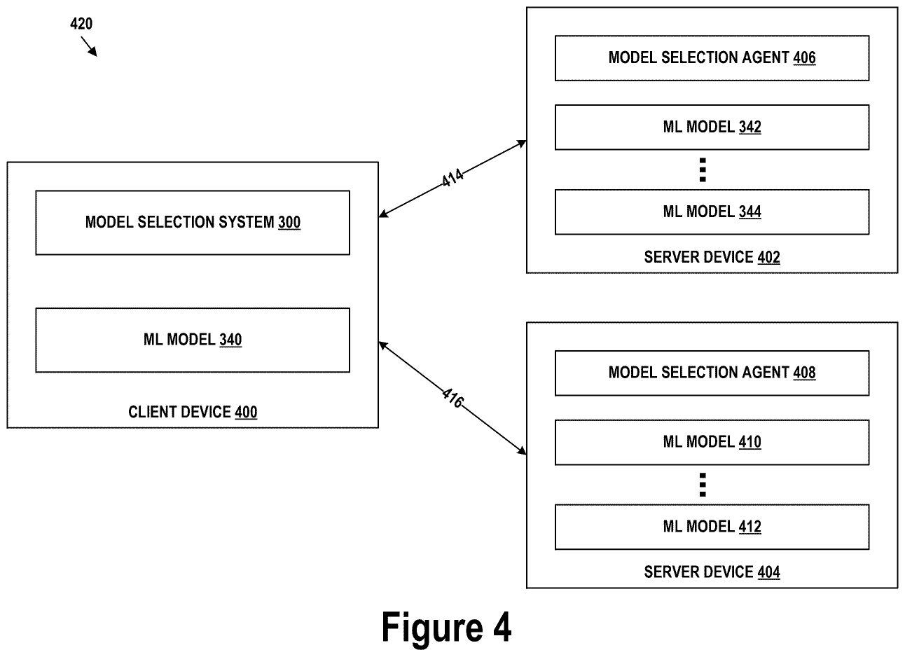

FIG. 4 illustrates an example arrangement of computing devices that may be used to route ML queries and execute various ML models. Specifically, computing system 420 may include client device 400, server device 402, and server device 404. Client device 400 may, for example, take the form of computing device 100. Client device 400 may include model selection system 300 and ML model 340. Server device 402 may include model selection agent 406 and ML models 342-344. Server device 404 may include model selection agent 408 and ML models 410 through 412 (i.e., “ML models 410-412”).

In some cases, input data 302 may be received using client device 400. Accordingly, model selection system 300 may be configured to determine whether to process input data 302 using client-side ML model 340 or one or more of server-side ML models 342-344 and/or 410-412. In other cases, such as when client device 400 does not include any client-side ML models, model selection system 300 may be configured to select one or more of server-side ML models 342-344 and/or 410-412 for processing of input data 302.

Model selection system 300 may be configured to communicate with model selection agent 406 to obtain attribute values relating to ML models 342-344, as indicated by arrow 414. Model selection system 300 may also be configured to communicate with model selection agent 408 to obtain attribute values relating to ML models 410-412, as indicated by arrow 416. Model selection agents 406 and 408 may represent, for example, applications, plug-ins, and/or other software components configured to collect information (e.g., any of the attribute values discussed herein) about the server-side ML models and/or the server devices, and provide this information to model selection system 300.

In some implementations, model selection system 300 may be configured to select among a plurality of different client-side ML models available on client device 400. In some implementations, model selection system 300 may be provided on, for example, server device 402, and may be configured to select among ML models 342-344 and/or ML models 410-412.

### V. Additional Example Operations

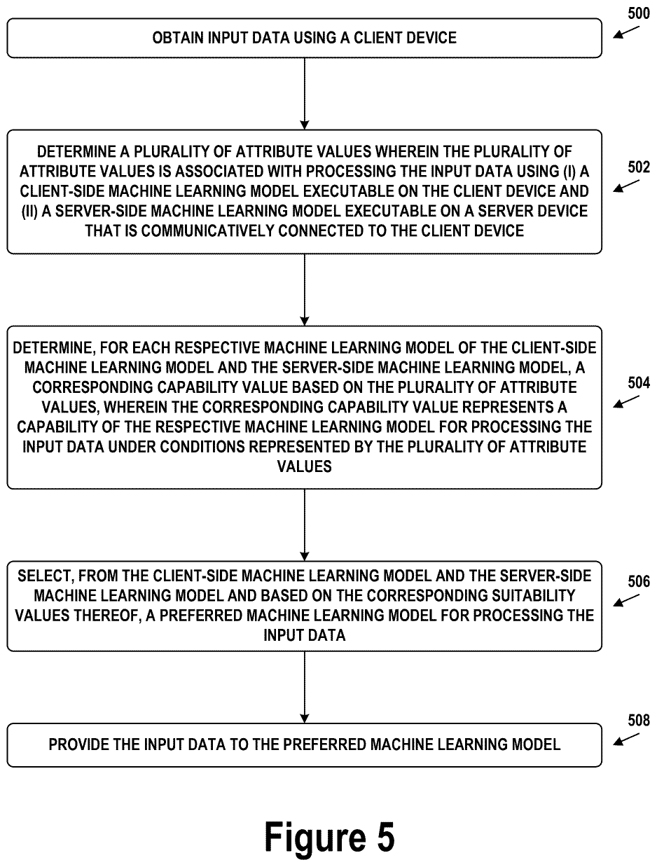

FIG. 5 illustrates a flow chart of operations related to selecting a machine learning model from a plurality of machine learning models available for processing of input data. The operations may be carried out by computing device 100, computing system 200, model selection system 300, and/or client device 400, among other possibilities. The embodiments of FIG. 5 may be simplified by the removal of any one or more of the features shown therein. Further, these embodiments may be combined with features, aspects, and/or implementations of any of the previous figures or otherwise described herein.

Block 500 may involve obtaining input data using a client device.

Block 502 may involve determining a plurality of attribute values. The plurality of attribute values may be associated with processing the input data using (i) a client-side machine learning model executable on the client device and (ii) a server-side machine learning model executable on a server device that is communicatively connected to the client device.

Block 504 may involve determining, for each respective machine learning model of the client-side machine learning model and the server-side machine learning model, a corresponding capability value based on the plurality of attribute values. The corresponding capability value may represent a capability of the respective machine learning model for processing the input data under conditions represented by the plurality of attribute values.

Block 506 may involve selecting, from the client-side machine learning model and the server-side machine learning model and based on the corresponding capability values thereof, a preferred machine learning model for processing the input data.

Block 508 may involve providing the input data to the preferred machine learning model.

In some examples, the plurality of attribute values may include a technical performance value that relates to a technical capability of the respective machine learning model for processing the input data. Determining the corresponding capability value may include determining a technical capability value based on the technical performance value. The corresponding technical capability value may quantify the technical capability of the respective machine learning model for processing the input data under the conditions represented by the plurality of attribute values.

In some examples, the technical performance value may include a task type value representing a task requested to be performed in connection with the input data.

In some examples, the technical performance value may include an input data type value representing a type of the input data.

In some examples, the technical performance value may include a context data type value representing a type of a context data associated with processing the input data.

In some examples, the technical performance value may include an output data type value representing a type of output data expected to be generated based on the input data.

In some examples, the technical performance value may include an input complexity value representing one or more of a size or a complexity of the input data.

In some examples, the technical performance value may include a context complexity value representing one or more of a size or a complexity of the context data.

In some examples, the technical performance value may include an output complexity value representing one or more of a size or a complexity of the output data.

In some examples, the technical performance value may include a network availability value representing availability of a network connection to the server device.

In some examples, the technical performance value may include an energy availability value representing an availability of energy for executing the respective machine learning model.

In some examples, the technical performance value may include a hardware availability value representing an availability of processing hardware (e.g., tensor processing hardware) for accelerating execution of the respective machine learning model.

In some examples, the plurality of attribute values may include a memory state value that represents a state of memory resources available to the respective machine learning model in connection with processing the input data. Determining the corresponding capability value may include determining a corresponding memory capability value based on the memory state value. The corresponding memory capability value may quantify a capability of the memory resources to facilitate execution of the respective machine learning model under the conditions represented by the plurality of attribute values.

In some examples, the memory state value may include a memory availability value representing availability of memory resources for executing the respective machine learning model.

In some examples, the memory state value may include a memory presence value representing whether the respective machine learning model has been preloaded into memory before processing of the input data thereby is requested.

In some examples, the memory state value may include a context availability value representing availability of a context data associated with processing the input data by the respective machine learning model.

In some examples, the memory state value may include a context cache value representing whether the context data is available in a cache memory associated with the respective machine learning model.

In some examples, the memory state value may include an input similarity value representing a similarity of the input data to prior input data provided to the respective machine learning model.

In some examples, the memory state value may include a query cache value representing whether the prior input data is available in the cache memory associated with the respective machine learning model.

In some examples, the plurality of attribute values may include a sensitivity value that represents a sensitivity associated with processing the input data. Determining the corresponding capability value may include determining a corresponding sensitivity capability value based on the sensitivity value. The corresponding sensitivity capability value may quantify a capability of the respective machine learning model for securely processing input data under the conditions represented by the plurality of attribute values.

In some examples, the sensitivity value may include a user-specified sensitivity value representing a user preference for using a particular machine learning model of the client-side machine learning model and the server-side machine learning model for processing the input data.

In some examples, the sensitivity value may include an input sensitivity value representing a sensitivity of content present in the input data.

In some examples, the sensitivity value may include a context sensitivity value representing a sensitivity of a context data associated with processing the input data by the respective machine learning model.

In some examples, the sensitivity value may include an output sensitivity value indicating that output data generated by the client-side machine learning model based on processing the input data is unsafe and is to be verified by processing the input data using the server-side machine learning model.

In some examples, the plurality of attribute values may include a latency value representing a latency associated with processing the input data by the respective machine learning model. Determining the corresponding capability value may include determining a corresponding latency capability value based on the latency value. The corresponding latency capability value may quantify the latency associated with processing the input data by the respective machine learning model under the conditions represented by the plurality of attribute values.

In some examples, the latency value may include a target latency value representing a latency with which output data is expected to be generated by the respective machine learning model based on the input data.

In some examples, the latency value may include a latency history value representing a latency with which the respective machine learning model provided one or more prior output data based on one or more prior input data.

In some examples, the plurality of attribute values may include a query retry value representing results of a prior attempt at processing the input data by the respective machine learning model. Determining the corresponding capability value may include determining a corresponding query retry capability value based on the query retry value. The corresponding query retry capability value may quantify a likelihood of a successful reattempt at processing input data by the respective machine learning model under the conditions represented by the plurality of attribute values.

In some examples, the query retry value may include an output acceptability value representing whether the respective machine learning model provided acceptable output data based on the prior attempt at processing the input data.

In some examples, the query retry value may include a query failure value representing whether the respective machine learning model failed to generate output data based on the prior attempt at processing the input data.

In some examples, determining the corresponding capability value may include determining a corresponding initial capability value for the respective machine learning model, and adjusting the corresponding initial capability value for the respective machine learning model based on (i) the plurality of attribute values and (ii) a corresponding predetermined weight assigned to each respective attribute value of the plurality of attribute values. The corresponding predetermined weight may indicate a relative importance of the respective attribute value in selecting the respective machine learning model.

In some examples, adjusting the corresponding initial capability value for the respective machine learning model may include assigning a value of zero to the corresponding capability value based on at least one of the plurality of attribute values indicating that the respective machine learning model is precluded from processing the input data.

In some examples, the corresponding initial capability value for the client-side machine learning model may be higher than the corresponding initial capability value for the server-side machine learning model to indicate an initial preference for using the client-side machine learning model over the server-side machine learning model.

In some examples, the corresponding initial capability value for the server-side machine learning model may be higher than the corresponding initial capability value for the client-side machine learning model to indicate an initial preference for using the server-side machine learning model over the client-side machine learning model.

In some examples, the plurality of attribute values may represent one or more of: (i) properties of the input data, (ii) properties of a context in which processing of the input data is requested, (iii) properties of output data expected to be generated based on the input data, (iv) a corresponding technical capability of each respective machine learning model, (v) a corresponding state of each respective machine learning model when processing of the input data is requested, or (vi) a user preference.

In some examples, the client-side machine learning model may be configured to perform a same task as the server-side machine learning model.

In some examples, selecting the preferred machine learning model for processing the input data may include determining a highest capability value of the corresponding capability values of the client-side machine learning model and the server-side machine learning model, and identifying a machine learning model corresponding to the highest capability value.

In some examples, each respective machine learning model of the client-side machine learning model and the server-side machine learning model may include a corresponding large language model (LLMs).

In some examples, the corresponding capability value of the client-side machine learning model may quantify an expected performance of the client-side machine learning model when executed in connection with the plurality of attribute values. The corresponding capability value of the server-side machine learning model may quantify an expected performance of the server-side machine learning model when executed in connection with the plurality of attribute values. The expected performance of the client-side machine learning model may differ from the expected performance of the server-side machine learning model.

In some examples, the preferred machine learning model may be selected using a decision tree and/or a graph structure.

### VI. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computer-implemented method comprising:
obtaining input data using a client device;
determining a plurality of attribute values, wherein the plurality of attribute values is associated with processing the input data using (i) a client-side machine learning model executable on the client device and (ii) a server-side machine learning model executable on a server device that is communicatively connected to the client device;
determining, for each respective machine learning model of the client-side machine learning model and the server-side machine learning model, a corresponding capability value based on the plurality of attribute values, wherein the corresponding capability value represents a capability of the respective machine learning model for processing the input data under conditions represented by the plurality of attribute values;
selecting, from the client-side machine learning model and the server-side machine learning model and based on the corresponding capability values thereof, a preferred machine learning model for processing the input data; and
providing the input data to the preferred machine learning model.

2. The computer-implemented method of claim 1, wherein the plurality of attribute values comprises a technical performance value that relates to a technical capability of the respective machine learning model for processing the input data, and wherein determining the corresponding capability value comprises:
determining a corresponding technical capability value based on the technical performance value, wherein the corresponding technical capability value quantifies the technical capability of the respective machine learning model for processing the input data under the conditions represented by the plurality of attribute values.

3. The computer-implemented method of claim 2, wherein the technical performance value comprises one or more of:
a task type value representing a task requested to be performed in connection with the input data,
an input data type value representing a type of the input data,
a context data type value representing a type of a context data associated with processing the input data,
an output data type value representing a type of output data expected to be generated based on the input data,
an input complexity value representing one or more of a size or a complexity of the input data,
a context complexity value representing one or more of a size or a complexity of the context data,
an output complexity value representing one or more of a size or a complexity of the output data,
a network availability value representing availability of a network connection to the server device,
an energy availability value representing an availability of energy for executing the respective machine learning model, or
a hardware availability value representing an availability of processing hardware for accelerating execution of the respective machine learning model.

4. The computer-implemented method of claim 1, wherein the plurality of attribute values comprises a memory state value that represents a state of memory resources available to the respective machine learning model in connection with processing the input data, and wherein determining the corresponding capability value comprises:
determining a corresponding memory capability value based on the memory state value, and wherein the corresponding memory capability value quantifies a capability of the memory resources to facilitate execution of the respective machine learning model under the conditions represented by the plurality of attribute values.

5. The computer-implemented method of claim 4, wherein the memory state value comprises one or more of:
a memory availability value representing availability of memory resources for executing the respective machine learning model,
a memory presence value representing whether the respective machine learning model has been preloaded into memory before processing of the input data thereby is requested,
a context availability value representing availability of a context data associated with processing the input data by the respective machine learning model,
a context cache value representing whether the context data is available in a cache memory associated with the respective machine learning model,
an input similarity value representing a similarity of the input data to prior input data provided to the respective machine learning model, or
a query cache value representing whether the prior input data is available in the cache memory associated with the respective machine learning model.

6. The computer-implemented method of claim 1, wherein the plurality of attribute values comprises a sensitivity value that represents a sensitivity associated with processing the input data, and wherein determining the corresponding capability value comprises:
determining a corresponding sensitivity capability value based on the sensitivity value, wherein the corresponding sensitivity capability value quantifies a capability of the respective machine learning model for securely processing input data under the conditions represented by the plurality of attribute values.

7. The computer-implemented method of claim 6, wherein the sensitivity value comprises one or more of:
a user-specified sensitivity value representing a user preference for using a particular machine learning model of the client-side machine learning model and the server-side machine learning model for processing the input data,
an input sensitivity value representing a sensitivity of content present in the input data,
a context sensitivity value representing a sensitivity of a context data associated with processing the input data by the respective machine learning model, or
an output sensitivity value indicating that output data generated by the client-side machine learning model based on processing the input data is unsafe and is to be verified by processing the input data using the server-side machine learning model.

8. The computer-implemented method of claim 1, wherein the plurality of attribute values comprises a latency value representing a latency associated with processing the input data by the respective machine learning model, and wherein determining the corresponding capability value comprises:
determining a corresponding latency capability value based on the latency value, wherein the corresponding latency capability value quantifies the latency associated with processing the input data by the respective machine learning model under the conditions represented by the plurality of attribute values.

9. The computer-implemented method of claim 8, wherein the latency value comprises one or more of:
a target latency value representing a latency with which output data is expected to be generated by the respective machine learning model based on the input data, or
a latency history value representing a latency with which the respective machine learning model provided one or more prior output data based on one or more prior input data.

10. The computer-implemented method of claim 1, wherein the plurality of attribute values comprises a query retry value representing results of a prior attempt at processing the input data by the respective machine learning model, and wherein determining the corresponding capability value comprises:
determining a corresponding query retry capability value based on the query retry value, wherein the corresponding query retry capability value quantifies a likelihood of a successful reattempt at processing input data by the respective machine learning model under the conditions represented by the plurality of attribute values.

11. The computer-implemented method of claim 10, wherein the query retry value comprises one or more of:
an output acceptability value representing whether the respective machine learning model provided acceptable output data based on the prior attempt at processing the input data, or
a query failure value representing whether the respective machine learning model failed to generate output data based on the prior attempt at processing the input data.

12. The computer-implemented method of claim 1, wherein determining the corresponding capability value comprises:
determining a corresponding initial capability value for the respective machine learning model; and
adjusting the corresponding initial capability value for the respective machine learning model based on (i) the plurality of attribute values and (ii) a corresponding predetermined weight assigned to each respective attribute value of the plurality of attribute values, wherein the corresponding predetermined weight indicates a relative importance of the respective attribute value in selecting the respective machine learning model.

13. The computer-implemented method of claim 12, wherein adjusting the corresponding initial capability value for the respective machine learning model comprises:
assigning a value of zero to the corresponding capability value based on at least one of the plurality of attribute values indicating that the respective machine learning model is precluded from processing the input data.

14. The computer-implemented method of claim 12, wherein:
the corresponding initial capability value for the client-side machine learning model is higher than the corresponding initial capability value for the server-side machine learning model to indicate an initial preference for using the client-side machine learning model over the server-side machine learning model; or
the corresponding initial capability value for the server-side machine learning model is higher than the corresponding initial capability value for the client-side machine learning model to indicate an initial preference for using the server-side machine learning model over the client-side machine learning model.

15. The computer-implemented method of claim 1, wherein the plurality of attribute values represent one or more of: (i) properties of the input data, (ii) properties of a context in which processing of the input data is requested, (iii) properties of output data expected to be generated based on the input data, (iv) a corresponding technical capability of each respective machine learning model, (v) a corresponding state of each respective machine learning model when processing of the input data is requested, or (vi) a user preference.

16. The computer-implemented method of claim 1, wherein the client-side machine learning model is configured to perform a same task as the server-side machine learning model.

17. The computer-implemented method of claim 1, wherein selecting the preferred machine learning model for processing the input data comprises:
determining a highest capability value of the corresponding capability values of the client-side machine learning model and the server-side machine learning model; and
identifying a machine learning model corresponding to the highest capability value.

18. The computer-implemented method of claim 1, wherein each respective machine learning model of the client-side machine learning model and the server-side machine learning model comprises a corresponding large language model (LLMs).

19. A processor configured to perform operations comprising:
obtaining input data using a client device;
determining a plurality of attribute values, wherein the plurality of attribute values is associated with processing the input data using (i) a client-side machine learning model executable on the client device and (ii) a server-side machine learning model executable on a server device that is communicatively connected to the client device;
determining, for each respective machine learning model of the client-side machine learning model and the server-side machine learning model, a corresponding capability value based on the plurality of attribute values, wherein the corresponding capability value represents a capability of the respective machine learning model for processing the input data under conditions represented by the plurality of attribute values;
selecting, from the client-side machine learning model and the server-side machine learning model and based on the corresponding capability values thereof, a preferred machine learning model for processing the input data; and
providing the input data to the preferred machine learning model.

20. A non-transitory computer-readable storage medium having stored thereon instructions that, when executed by a computing device, cause the computing device to perform operations comprising:
obtaining input data using a client device;
determining a plurality of attribute values, wherein the plurality of attribute values is associated with processing the input data using (i) a client-side machine learning model executable on the client device and (ii) a server-side machine learning model executable on a server device that is communicatively connected to the client device;
determining, for each respective machine learning model of the client-side machine learning model and the server-side machine learning model, a corresponding capability value based on the plurality of attribute values, wherein the corresponding capability value represents a capability of the respective machine learning model for processing the input data under conditions represented by the plurality of attribute values;
selecting, from the client-side machine learning model and the server-side machine learning model and based on the corresponding capability values thereof, a preferred machine learning model for processing the input data; and
providing the input data to the preferred machine learning model.
